(19) United States
(12) Patent Application Publication
(10) Pub. No.: US 2006/0069991 A1
(43) Pub. Date: Mar. 30, 2006

(54) Pictorial and vocal representation of a multimedia document

(75) Inventors: Pascal Filoche, Perros-Guirec (FR); Frederic Martin, Betton (FR); Gilles Le Calvez, Perros-Guirec (FR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: FRANCE TELECOM, Paris (FR)

(21) Appl. No.: 11/233,381

(22) Filed: Sep. 23, 2005

(30) Foreign Application Priority Data
Sep. 24, 2004 (FR) 0410162

(51) Int. Cl. G06F 17/24; G06F 17/21; G06F 17/27

(52) U.S. Cl. 715/530; 715/513; 715/500.1; 704/9

(57) ABSTRACT

A representation server comprises a parser for transforming a multimedia document into a pre-analyzed document describing elements of the multimedia document, modules for determining the background and form characteristics of the pre-analyzed document, and a central unit for selecting pictorial characteristics as a function of the background and form characteristics of the pre-analyzed document. The central unit generates a pictorial representation of the multimedia document as a function of the pictorial characteristics. The server also comprises a module for determining a vocal representation of the document.

### BACKGROUND OF THE INVENTION

1. Field of the Invention

The present invention relates to a method of generating a pictorial representation of a multimedia document. The invention also pertains to a method of generating a vocal representation of a multimedia document to be associated with the pictorial representation of the document.

2. Description of the Prior Art

Currently, it is difficult to obtain a fast and complete appreciation of a multimedia document without going right through it. Automatically or manually devised summaries of a multimedia document offer an alternative, but require yet more time and willpower to read them.

There therefore exists a need to employ a representation of a document facilitating a fast and intuitive grasp of the subject matter of the document.

### OBJECT OF THE INVENTION

The object of the invention is therefore to provide automatically a pictorial and possibly vocal representation of a multimedia document so as to remedy the aforesaid drawbacks.

### SUMMARY OF THE INVENTION

To achieve this objective, a method for generating a pictorial representation of a multimedia document is characterized in that it comprises the steps of:
transforming the multimedia document into a pre-analyzed document describing elements of the multimedia document,
determining background and form characteristics of the pre-analyzed document,
selecting pictorial characteristics as a function of the background and form characteristics of the pre-analyzed document, and
generating a pictorial representation of the multimedia document as a function of the pictorial characteristics selected.

The step of determining the background and form characteristics of the pre-analyzed document may comprise various steps some of which depend on lexical, syntactic and semantic characteristics of the pre-analyzed document, as will be seen in the remainder of the description.

The pictorial representation of the multimedia document may be associated with a vocal representation. The method then comprises the steps of:
selecting a text to be synthesized as a function of the pre-analyzed document and background and form characteristics of the pre-analyzed document,
determining background and form characteristics of the selected text to be synthesized,
selecting the vocal characteristics as a function of the background and form characteristics of the pre-analyzed document and of the selected text to be synthesized, and
vocally synthesizing the text to be synthesized as a function of the vocal characteristics selected.

The invention also relates to a computing device for generating a pictorial representation of a multimedia document. The device is characterized in that it comprises:
means for transforming the multimedia document into a pre-analyzed document describing elements of the multimedia document,
means for determining background and form characteristics of the pre-analyzed document,
means for selecting pictorial characteristics as a function of the background and form characteristics of the pre-analyzed document, and
means for generating a pictorial representation of the multimedia document as a function of the pictorial characteristics selected.

The computing device may also comprise the following means:
means for selecting a text to be synthesized as a function of the pre-analyzed document and the background and form characteristics of the pre-analyzed document,
means for determining background and form characteristics of the selected text to be synthesized,
means for selecting vocal characteristics as a function of the background and form characteristics of the pre-analyzed document and of the selected text to be synthesized, and
means for vocally synthesizing the text to be synthesized as a function of the vocal characteristics selected.

### BRIEF DESCRIPTION OF THE DRAWINGS

Other features and advantages of the invention will be apparent more clearly from the reading of the following description of several preferred embodiments of the invention, with reference to the corresponding accompanying drawings in which:

FIG. 1 is a schematic block diagram of a system for generating a pictorial and vocal representation implementing a method of generating a pictorial representation according to a preferred embodiment of the invention;

FIG. 2 is an algorithm of the method for generating a pictorial representation according to the invention; and

FIG. 3 is an algorithm of the method for generating a vocal representation according to the invention implementing the method of generating a pictorial representation according to the invention.

### DESCRIPTION OF THE PREFERRED EMBODIMENTS

In the remainder of the description, a multimedia document is a digital file comprising at least text and possibly at least one image and/or at least one video, i.e. one sequence of animated images. A multimedia document is for example a page in the HTML (HyperText Markup Language) format or a document arising from text processing.

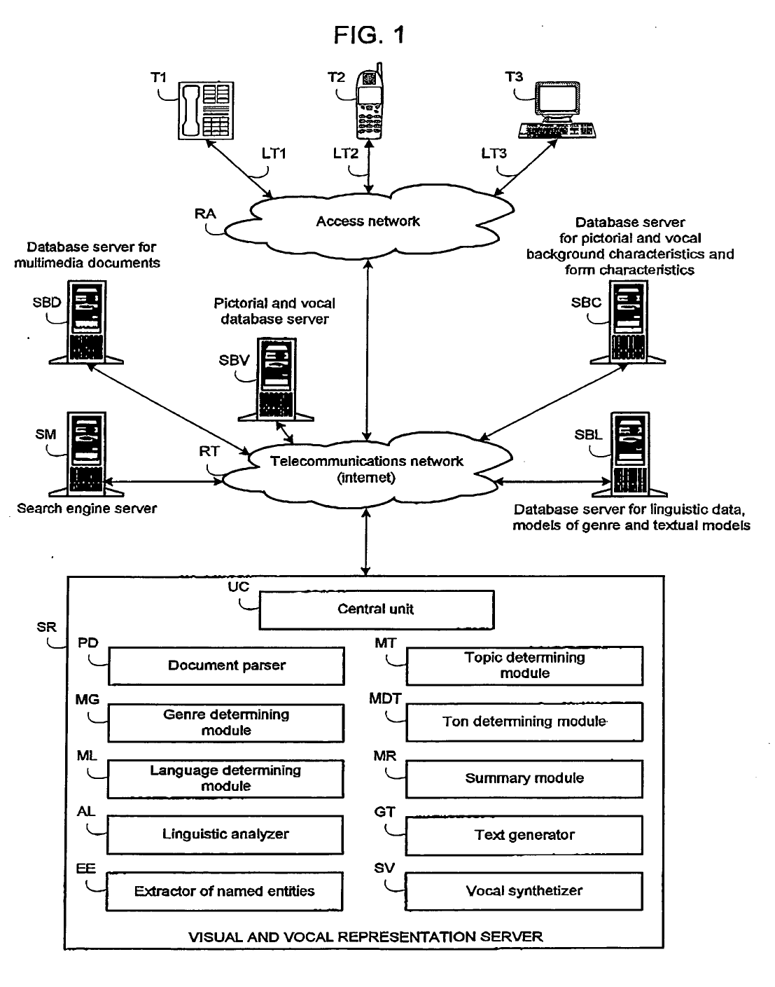

With reference to FIG. 1, the system for generating a pictorial and vocal representation comprises mainly a pictorial and vocal representation server SR, a database server for multimedia documents SBD, a pictorial and vocal database server SBV, a database server for pictorial and vocal background and form characteristics SBC, and a database server SBL including linguistic data, models of genre and textual models.

The pictorial and vocal representation server SR comprises mainly a central unit UC, a document parser PD, a genre determining module MG, a language determining module ML, a linguistic analyzer AL, an extractor of named entities EE, a topic determining module MT, a tone determining module MDT, a summary module MR, a text generator GT and a vocal synthesizer SV. Most of the aforesaid functional means in the server SR, with the exception of the central unit UC and of the vocal synthesizer SV, may be software modules.

The pictorial and vocal database server SBV comprises pictorial and vocal elements matched up with pictorial and vocal characteristics respectively. For example, a pictorial element is an image of the Eiffel Tower, and a vocal element is a parameter set defining a voice of a famous male personality.

In the preferred embodiment shown in FIG. 1, only three user terminals T1, T2 and T3 have been represented, designated interchangeably by T in the remainder of the description. In the preferred embodiment of the invention, a user terminal T dispatches a document search request to a search engine server SM. The search engine server performs a search for documents in the multimedia document database server SBD in response to the search request from the user terminal T. Before dispatching the documents corresponding to the result of the search to the user terminal T, the search engine server SM requests the representation server SR for pictorial and possibly vocal representations of the documents corresponding to the result of the search. The representation server SR returns pictorial and possibly vocal representations of the documents corresponding to the result of the search to the search engine server SM. The search engine server SM enhances the presentation of the results of the search to be dispatched to the user terminal T by pictorial and possibly vocal representations according to the invention.

The pictorial and/or vocal representations are generated either in real time with respect to the request of the user terminal T, or prior to the request of the user terminal, for example during the indexing of the documents by the search engine server.

A pictorial or visual representation of a textual document according to the invention is at least one image which makes it possible at the outset to intuitively grasp the subject matter of the document.

The terminal T is linked to a respective access network RA by a link LT. The terminal T is for example a mobile radiocommunications terminal T1, the link LT1 is a radiocommunications channel, and the respective access network RA comprises the fixed network of a cellular radiocommunications network, for example of GSM (Global System for Mobile communications) type with a GPRS (General Packet Radio Service) service, or of UMTS (Universal Mobile Telecommunications System) type.

According to another example, the terminal T is a personal computer T2, linked directly by modem to the xDSL or ISDN (Integrated Services Digital Network) line type link LT2 linked to the corresponding access network RA.

According to another example, the terminal T is a fixed telecommunications terminal T3, the link LT3 is a telephone line and the respective access network RA comprises the switched telephone network.

According to other examples, the user terminal T comprises a telecommunications electronic device or object personal to the user, which may be a communicating personal digital assistant PDA. The terminal T may be any other domestic terminal portable or otherwise such as a video games console, or an intelligent television receiver cooperating with a remote control with display or with alphanumeric keypad also serving as mouse through an infrared link.

According to another example, the access network RA comprises a network for attaching several user terminals.

The user terminals T and the access networks RA are not limited to the examples above and may consist of other known terminals and access networks.

The database servers SBD, SBV, SBC and SBL communicate with the representation server SR through a telecommunications network RT, such as the Internet, linked to the access networks RA. The search engine server SM communicates with the multimedia document database server SBD through the telecommunications network RT.

As a variant, at least one of the database servers SBD, SBV, SBC and SBL communicates locally with the representation server SR.

In other variants, the data in the database servers SBD, SBV, SBC and SBL are distributed in one, two or three database servers.

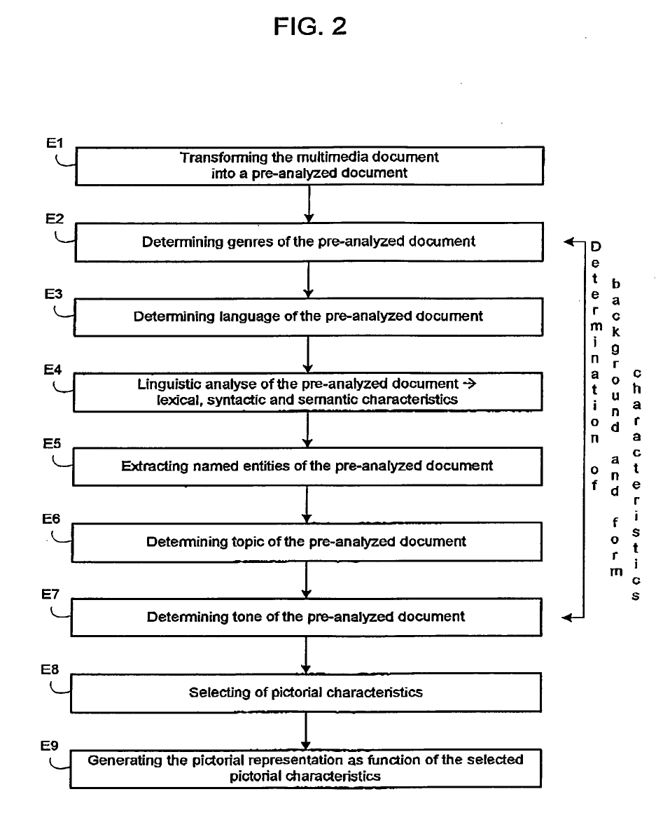

With reference to FIG. 2, the method for generating a pictorial representation of a multimedia document stored initially in the database server for multimedia documents SBD comprises, according to the invention, steps E1 to E9 executed automatically in the representation server SR.

In step E1, the document parser PD transforms the multimedia document into a pre-analyzed document, so that the other modules in the representation server SR use and interpret the pre-analyzed document regardless of the format of the document. The pre-analysis consists in analyzing the multimedia document and in creating from the multimedia document and the analysis, a pre-analyzed document containing and describing the various elements of the multimedia document. A multimedia document element is for example, a paragraph, a title, an image, a table, or a word. The pre-analyzed document contains element descriptions such as word underlining, word emboldening, image layouts, videos, bullets, etc.

Steps E2 to E7 consist in determining background and form characteristics of the elements of the multimedia document and therefore of the pre-analyzed document. Other steps may be added to determine other background and form characteristics.

In step E2, the genre determining module MG determines a genre of the pre-analyzed document. The genre of the document defines the style, the content and the graphics of the document. For example, the genre is a newsflash, a sports result, a technical document, a scientific paper, a patent, a cookery recipe, or a page of a personal Internet site. To determine the genre of the document, the genre determining module MG compares the pre-analyzed document with genre models stored in the database server SBL and selects the genre associated with the model of genre closest to the pre-analyzed document. When no genre model can be selected, a default genre is selected. The genre models comprise information serving to delineate the genre of a document, such as information about the words or expressions used, or the graphical form. The genre of the pre-analyzed document is stored matched up with the multimedia document in the characteristics database server SBC.

In step E3, the language determining module ML determines the language, including a dialect or a patois, of the pre-analyzed document as a function of the lexical and morphological criteria; for example the language is French, English, Chinese or Breton. The language of the document is stored matched up with the multimedia document in the characteristics database server SBC.

In step E4, the linguistic analyzer AL analyzes the pre-analyzed document to determine lexical information such as lemmas of words used and topics dealt with in the document, syntactic information such as grammatical functions of words used, splitting of phrases into nominal and verbal groups, and semantic information. All this information is stored matched up with the multimedia document in the characteristics database server SBC.

In step E5, the extractor of named entities EE extracts named entities, for example names of persons, of places, of brands and of companies, from the pre-analyzed document as a function of the lexical, syntactic and semantic characteristics determined and provided by the linguistic analyzer AL. The named entities are stored matched up with the multimedia document in the characteristics database server SBC.

In step E6, the topic determining module MT determines a topic or principal topics dealt with by the pre-analyzed document as a function of statistical measurements carried out on the lexical, syntactic and semantic characteristics and possibly as a function of the information contained in a thesaurus. For example, a thesaurus matches up topics with sets of words, and the topic determining module MT determines for each set of words the sum of the repetitions of each word of the set in the pre-analyzed document, and selects the topic associated with the word set having the maximum sum of repetitions. The topic is stored matched up with the multimedia document in the characteristics database server SBC.

In step E7, the tone determining module MDT determines the tone of the pre-analyzed document on the basis of words, expressions and syntactic turns of phrase included in the pre-analyzed document which are extracted from the pre-analyzed document as a function of the lexical, syntactic and semantic characteristics determined in step E4. For example, the tone determining module MDT uses a lexicon of words each of which is associated with a respective positive or negative character. In this example, the module MDT determines the tone as a function of the number of words associated with the positive or negative characters. The tone of a document is for example happy, sad, positive or negative. The tone of the document is stored matched up with the multimedia document in the characteristics database server SBC.

The paragraphs, the titles, the underlined words, the words in bold, the layouts of the images, the videos, the genre, the language, the lexical, syntactic and semantic information, the named entities, at least one topic and the tone are in part background characteristics and in part form characteristics of the pre-analyzed document. Generally, a language, a named entity and a topic are background characteristics. A genre and a topic are form characteristics.

In step E8, the central unit UC selects in the characteristics database server SBC pictorial characteristics of the pre-analyzed document as a function of the background and form characteristics determined in the characteristics database server SBC, in steps E2 to E7. For example, for a given multimedia document, the genre is “stock market prices”, the topic “economics” and the language “French”, and the corresponding pictorial characteristics are an image portraying a “trader” possibly followed, against a backdrop consisting of an image, by the “frontage of the Paris stock exchange”. In another example, the genre is “news release”, the topic “economics”, the tone “journalistic” and a named entity “Orange”, and the corresponding pictorial characteristics are an image representing a “serious journalist” against a backdrop consisting of the “Orange” logo.

In step E9, the central unit UC generates the pictorial representation as a function of the pictorial characteristics of the pre-analyzed document. To do this, the central unit UC selects pictorial elements corresponding to the pictorial characteristics determined in the pictorial and vocal database server SBV. The pictorial representation is stored matched up with the multimedia document. The pictorial representation of the document may be static (image) or dynamic (animation).

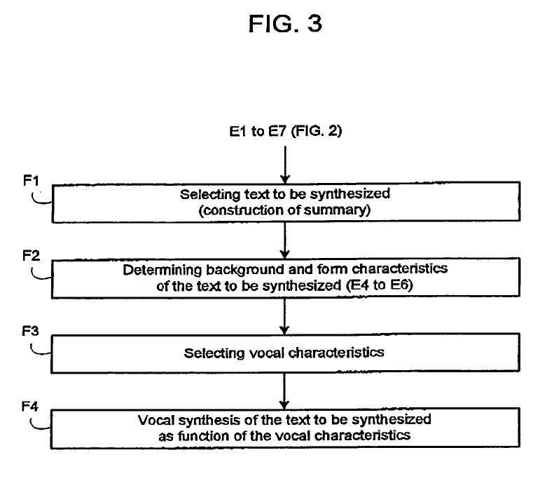

The pictorial representation of a multimedia document may be associated with a vocal representation. With reference to FIG. 3, a generation of vocal representation comprises steps F1 to F4 supplementing the representation generating method according to the invention and executed likewise automatically in the representation server SR.

The vocal representation may be matched up with the movements of the dynamic pictorial representation.

In step F1, the central unit UC in the representation server SR selects the text to be synthesized as a function of the pre-analyzed document described in step E1 and the background and form characteristics determined previously in steps E2 to E7.

For example, when the multimedia document comprises a title in bold, the text to be synthesized is the title. In the converse case, the summary module MR selects text parts of the pre-analyzed document which are representative of the multimedia document as a function of the background and form characteristics determined previously, in particular as a function of statistical measurements performed on the lexical, syntactic and semantic information, so that the module MR automatically constructs a summary of the multimedia document as text to be synthesized.

In another example, when the pre-analyzed document contains no or little text, the text generator GT generates a text to be synthesized as a function of the pre-analyzed document, background and form characteristics of the pre-analyzed document, and prestored textual models read from the database server SBL. The text generator GT generates a text that can be understood orally by selecting a textual model as a function of the background and form characteristics and possibly by supplementing the textual model selected with textual information extracted from the pre-analyzed document. For example, the pre-analyzed document comprises a table of stock market prices, the generator GT then selects the textual model corresponding to the announcement of stock market prices of the type “the stock market price of <share, indices . . . > is currently <value>”, and the generator replaces <share, indices, . . . > and <value> with data from the table, this possibly generating the following text “the stock market price of the CAC40 index is currently 3750”. The text thus generated is the text to be synthesized.

In a variant, correctors of orthographic and/or grammatical type correct the text to be synthesized.

In step F2, background and/or form characteristics of the text to be synthesized are determined. To do this, steps E3, E4, E5, E6 and E7 are applied to the selected text to be synthesized, so as to determine lexical, syntactic and semantic information, named entities, one or more topics and one or more tones of the text to be synthesized. The topic determining module MT also determines textual positions corresponding to the various topics, that is to say the textual parts corresponding to a particular topic, and textual positions corresponding to the various tones.

In step F3, the central unit UC selects in the characteristics database server SBC vocal characteristics of the pre-analyzed document as a function of the background and form characteristics determined in steps E2 to E7 and as a function of the background and form characteristics of the text to be synthesized that were determined in step F2. For example, for a given multimedia document whose genre is “information page”, whose language is “French”, whose document topic is “agriculture” and the tone of whose text to be synthesized is “serious”, the vocal characteristics selected are a “male” voice, a “French rural” accent and a “wind over a wheat field” sound background.

In step F4, the vocal synthesizer SV synthesizes the text to be synthesized as a function of the vocal characteristics so as to generate the vocal representation of the document. To do this, the vocal synthesizer SV selects vocal elements corresponding to the vocal characteristics determined in the pictorial and vocal database server SBV. The synchronization between the pictorial representation and the vocal representation of the document is carried out in particular as a function of the textual positions corresponding to the various topics and/or tones of the text to be synthesized such as the summary.

The matches envisaged between the background and form characteristics and the vocal characteristics are not limited to the examples hereinbelow. The vocal characteristics may lead for example to the addition of predefined sound elements such as jingles and snatches of music (for example associated with the named entities extracted), of accents imitative of known presenters, hosts and actors, of sound effects such as tremolo, chorus and robot, of sound emotions such as crying, laughing, and stammering.

In a variant, the matches between the background and form characteristics and the pictorial and/or vocal characteristics depend on the field of application of the invention.

In another variant, the matches depend also on the profile of a user who has taken out a subscription to a service implementing the method of the invention.

In another variant, a facial animation engine synchronizes the movements of the personality of the pictorial representation of the document, in particular the lip movements, with the vocal representation of the document.

The invention described here relates to a method and a system for generating a pictorial and vocal representation. According to a preferred implementation, the steps of the method are determined by the instructions of a program for generating a pictorial and vocal representation of a multimedia document incorporated into a computing device such as the pictorial and vocal representation server SR. The program comprises program instructions which, when said program is loaded and executed in the computing device whose operation is then controlled by the execution of the program, carry out the steps of the method according to the invention.

As a consequence, the invention applies also to a computer program, in particular a computer program on or in an information medium, adapted to implement the invention. This program can use any programming language whatsoever and be in the form of source code, object code, or code intermediate between source code and object code such as in a partially compiled form, or in any other form whatsoever desirable to implement a method according to the invention.

The information medium may be any entity or device whatsoever capable of storing the program. For example, the medium may comprise a means of storage, such as a ROM, for example a CD ROM or a microelectronic circuit ROM or else a magnetic recording means, for example a floppy disk or a hard disk.

Moreover, the information medium may be a transmissible medium such as an electrical or optical signal, which may be routed via an electrical or optical cable, by radio or by other means. The program according to the invention may in particular be downloaded on an Internet type network.

Alternatively, the information medium may be an integrated circuit in which the program is incorporated, the circuit being adapted to execute or to be used in the execution of the method according to the invention.

What we claim is:

1. A method in a computing device for generating a pictorial representation of a multimedia document, comprising the following steps of:
transforming said multimedia document into a pre-analyzed document describing elements of said multimedia document,
determining background and form characteristics of said pre-analyzed document,
selecting pictorial characteristics as a function of said background and form characteristics of said pre-analyzed document, and
generating a pictorial representation of said multimedia document as a function of said pictorial characteristics selected.

2. A method according to claim 1, according to which the step of determining background and form characteristics of said pre-analyzed document comprises at least one of the following steps:
determining a genre of said pre-analyzed document as one of said background and form characteristics by comparing said pre-analyzed document with genre models stored in a server means, and
determining a language of said pre-analyzed document as one of said background and form characteristics.

3. A method according to claim 1, according to which the step of determining background and form characteristics of said pre-analyzed document comprises the following steps:
determining lexical, syntactic and semantic characteristics of said pre-analyzed document as background and form characteristics,
extracting named entities from said pre-analyzed document as background and form characteristics as a function of said lexical, syntactic and semantic characteristics determined.

4. A method according to claim 1, according to which the step of determining background and form characteristics of said pre-analyzed document comprises the following steps:
determining lexical, syntactic and semantic characteristics of said pre-analyzed document as background and form characteristics, and
determining a topic of said pre-analyzed document as one of said background and form characteristics as a function in particular of statistical measurements carried out on said lexical, syntactic and semantic characteristics.

5. A method according to claim 1, according to which the step of determining background and form characteristics of said pre-analyzed document comprises the following steps:
determining lexical, syntactic and semantic characteristics of said pre-analyzed document as background and form characteristics, and
determining a tone of said pre-analyzed document as one of said background and form characteristics on the basis of words, expressions and syntactic turns of phrase included in said pre-analyzed document which are extracted from said pre-analyzed document as a function of said lexical, syntactic and semantic characteristics determined.

6. A method according to claim 1, comprising the steps of:
selecting a text to be synthesized as a function of said pre-analyzed document and background and form characteristics of said pre-analyzed document,
determining background and form characteristics of the selected text to be synthesized,
selecting said vocal characteristics as a function of said background and form characteristics of said pre-analyzed document and said background and form characteristics of said selected text to be synthesized, and
vocally synthesizing said text to be synthesized as a function of said vocal characteristics selected.

7. A method accordance to claim 6, comprising a construction of a summary of said multimedia document as said text to be synthesized by selecting text parts of said pre-analyzed document which are representative of said multimedia document as a function of said background and form characteristics of said pre-analyzed document.

8. A method according to claim 6, comprising, when said pre-analyzed document contains little text, a generation of a text to be synthesized as a function of said pre-analyzed document, background and form characteristics of said pre-analyzed document, and textual models stored in a server means.

9. A computing device for generating a pictorial representation of a multimedia document, comprising:
means for transforming said multimedia document into a pre-analyzed document describing elements of said multimedia document,
means for determining background and form characteristics of said pre-analyzed document,
means for selecting pictorial characteristics as a function of said background and form characteristics of said pre-analyzed document, and
means for generating a pictorial representation of said multimedia document as a function of said pictorial characteristics selected.

10. A computing device according to claim 9, comprising:
means for selecting a text to be synthesized as a function of said pre-analyzed document and said background and form characteristics of said pre-analyzed document,
means for determining background and form characteristics of the selected text to be synthesized,
means for selecting vocal characteristics as a function of said background and form characteristics of said pre-analyzed document and said background and form characteristics of said selected text to be synthesized, and
means for vocally synthesizing said text to be synthesized as a function of said vocal characteristics selected.

11. A computer program on an information medium for generating a pictorial representation of a multimedia document in a computing device, said program including program instructions which, when said program is loaded and executed in said computing device, carry out the following steps of:
transforming said multimedia document into a pre-analyzed document describing elements of said multimedia document,
determining background and form characteristics of said pre-analyzed document,
selecting pictorial characteristics as a function of said background and form characteristics of said pre-analyzed document, and
generating a pictorial representation of said multimedia document as a function of said pictorial characteristics selected.
